(19) United States
(12) Patent Application Publication
(10) Pub. No.: US 2009/0258432 A1
(43) Pub. Date: Oct. 15, 2009

(54) Composition and Method

(75) Inventors: Wolodymyr Hluchan, West Yorkshire (GB); Andrew Sutulic, West Yorkshire (GB)

Correspondence Address: NIXON & VANDERHYE, PC, 901 NORTH GLEBE ROAD, 11TH FLOOR, ARLINGTON, VA, 22203, US

(73) Assignee: POLYSEAM LIMITED, Huddersfield (GB)

(21) Appl. No.: 12/086,305

(22) PCT Filed: Nov. 6, 2006
(86) PCT No.: PCT/GB2006/004126

§ 371 Date: Jul. 8, 2008

(30) Foreign Application Priority Data
Jan. 7, 2006 (GB) 0600261.2

(51) Int. Cl. G01N 21/78; C09K 21/00

(52) U.S. Cl. 436/164; 252/601; 252/607

(57) ABSTRACT

A fire-stop product comprising a characterising marker, wherein the presence of said characterising marker can be detected by a diagnostic method at the site where the product is located.

The present invention relates to fire-stop products, and methods relating thereto. In particular, the present invention relates to fire-stop sealants, fire-stop coatings, fire-stop adhesives and fire-stop putties.

In building construction, materials used to make, for example, walls and doors are generally able to act as a fire barrier for a sufficient time to enable a building to be safely evacuated. They also serve to contain a fire within a specific area for a limited period. However, the region where a door fits into a wall, or the region where a wall joins the ceiling or where a pipe, for example, passes through a wall, may be considered as an area where there is a break in this fire barrier. It is therefore common practice to use sealants, putties, coatings, adhesives and the like which contain a fire-resistant compound. These products (hereinafter fire-stop products) are able to help contain the fire within a confined area defined by the doors and walls.

Fire-stop products typically char and swell rather than burn and thus form a fire barrier. A fire-stop product is selected according to its rating. This rating relates to the time for which the product will typically maintain a fire barrier, and is dependent upon the amount of product used and the quantities of fire-resistant components present therein.

A fire-stop product is typically selected to have a rating which will match the room in which it is used. For example, in particular a room of a building, if the least fire-resistant part of the building is the door, and this will burn in one hour, then a fire-stop product having a rating of at least one hour would typically be selected.

When architects design buildings, they often specify particular fire-stop products which should be used in certain parts of the building.

Insurance companies often insure buildings based on the knowledge that the specified fire-stop products are in fact used in the places detailed.

However, fire-stop products are often applied at the end of construction. At this time, people may be running over-budget or may wish to finish a job quickly, and it is sometimes the case that the correct fire-stop product is not used. For example, a fire-stop product having a lower rating which is less expensive may be used in place of a fire-stop product having a higher rating. Or, alternatively, a product which does not comprise any fire-stopping agent may be used. This can have very serious consequences.

If a fire is not able to be contained within a specific area of a building for a sufficient period, people may not be able to be evacuated as quickly as necessary.

In addition, fire may spread much more rapidly and many more rooms or areas of the building may be damaged than would have been the case if the correct fire-stop product had been used.

As the consequences of using the wrong fire-stopping product may be so grave, it is highly desirable to check that the correct product has been used when building construction or, for example renovation, is complete.

Insurance companies often require proof that the correct fire-stop product has been used. Some firms of builders may give guarantees or certificates. However the inadequacy of these may only be revealed when it is already too late.

It may be possible to take a sample of a fire-stop product from a building to a laboratory for analysis. However, this would be cumbersome, time-consuming and expensive.

According to a first aspect of the present invention, there is provided a fire-stop product comprising a characterising marker, wherein the presence of said characterising marker can be detected by a diagnostic method at the site where the product is located.

By the site where the product is located is meant the building or area thereof in which the product is used. This does not necessarily mean the specific location in terms of the actual joint or the like in which the product is placed, but refers to the vicinity of this joint, for example the room in which the joint is found. Thus, the product may be removed from the joint and tested at that location, in the immediate vicinity of the joint (or other place) from which it was removed.

However an embodiment in which the fire-stop product is tested in situ, for example without removing a sample of the product is within the scope of the invention.

The diagnostic method by which the characterising marker of the fires-stop product may be identified is defined below, in relation to the second aspect of the present invention.

The characterising marker is preferably a stable chemical component which can be detected in the fire-stop product after a period of at least 1 week, preferably at least 1 month, preferably at least 3 months, preferably at least 6 months, preferably at least a year, more preferably at least 5 years, and most preferably at least 10 years.

The characterising marker is preferably present in the fire-stop product in an amount of at least 0.001 wt %, more preferably at least 0.005 wt %, more preferably at least 0.01 wt %, more preferably at least 0.05 wt %, and most preferably at least 0.09 wt %.

The characterising marker of the fire-stop product is preferably present in an amount of up to 20 wt %, preferably up to 10 wt %, more preferably up to 5 wt %, preferably up to 1 wt %, preferably up to 0.5 wt %, preferably up to 0.3 wt %, more preferably up to 0.2 wt %, preferably up to 0.15 wt %, most preferably up to 0.11 wt %.

The characterising marker may comprise any suitable component which may be detected by a diagnostic method.

A characterising marker may comprise a component which is revealed under certain conditions, for example under UV light, or when a chemical or heat or other external stimulus is applied. Thus in such embodiments, identification of the marker in situ may be possible.

Preferably the characterising marker comprises a chemical component which may be selectively extracted using a solvent system. Other components may also be extracted, but preferably they are not. In embodiments in which further components are also extracted, it is possible to uniquely identify the marker by a diagnostic test, despite the presence of said further components. Any suitable solvent system may be used, as is discussed below with respect to the method of the second aspect of the invention.

The characterising marker may comprise a single chemical compound or may comprise a mixture of two or more chemical compounds. For example, the characterising marker may comprise two compounds which when present in a solid fire-stop product do not react but when both are dissolved in a solvent system, a chemical reaction occurs. This chemical reaction may be accompanied by, for example, heat, effervescence, or, a colour change.

The characterising marker may be such that it may be detected by any simple diagnostic method.

The characterising marker may comprise a moiety (a chromophore) such that it may be detected by UV radiation.

The characterising marker may comprise a compound which can be detected by chromatography.

The characterising marker may comprise functional groups which allow it to be detected by Infra-red, Raman, or another type of spectroscopy.

Preferably the characterising marker of the fire-stop product of the present invention may be identified by a visual method.

Preferably the characterising marker of the present invention is initially invisible and is detected because in the diagnostic method used to detect the marker, a colour change occurs.

Preferably the characterising marker of the fire-stop product of the present invention comprises a pH indicator. Suitably the pH indicator undergoes a physical change when there is a change in pH of its environment. Preferably the physical change is a colour change. Thus the fire-stop composition of the present invention preferably comprises a component which is one colour when placed in an environment having a first pH and is a different colour when placed in an environment having a second pH.

The characterising marker present in the fire-stop product of the composition of the present invention may be identified due to the colour change which occurs on the change of pH.

Any component which undergoes a colour change upon a change in pH may be used as the characterising marker in the product of the present invention. pH indicators which are suitable include methyl violet, crystal violet, ethyl violet, malachite green, methyl green, cresol red, thymol blue, bromophenol blue, congo red, methyl orange, resorcin blue, alizarin red, methyl red, litmus, bromoceresol purple, chrophenol red, bromothymol blue, phenol red, neutral red, tumaric curcumin, phenolphthalein, thymophthalein, alizarin yellow, clayton yellow, pentamethoxy red, tropeolin 00, 2,4-dinitrophenol, methyl yellow, tetrabromophenol blue, alizarin sodium sulfonate, α-naphthyl red, p-ethoxychrysoidine, bromocresol green, chlorophenol red, p-nitrophenol, azolitmin, rosolic acid, α-Naphtholphthalein, tropeolin 000, 60 -Naphtholbenzein, thymolphthalein, Nile blue, alizarin yellow, salicyl yellow, diazo violet, tropeolin 0, nitramine, Poirrier's blue and trinitrobenzoic acid.

Preferably the characterising marker comprises a compound which may be provided at a first pH in colourless form.

Preferably the characterising marker is colourless at neutral pH.

Most preferably the characterising marker comprises phenolphthalein.

Preferably the characterising marker comprises solid phenolphthalein.

In some embodiments, the fire-stop product of the first aspect of the present invention may comprise one or more further characterising markers in addition to the first. This would enable the same product to be supplied to a number of consumers, each of which would be able to use a different diagnostic test to identify the product. This would also allow identification of the product using more than one test, providing increased guarantee as to the source of the fire-stop product.

The fire-stop product may comprise any suitable product used in construction in which the inclusion of a characterising marker would be a desirable feature. These include fire-stop sealants, fire-stop coatings, fire-stop adhesives and fire-stop putties.

Such products typically comprise polymers and/or binders, fillers, fire retardant components and additives. Fire-stop products of the present invention preferably comprise 5 to 95 wt % polymer, preferably 10 to 80 wt %, more preferably 20 to 60 wt %, preferably 25 to 50 wt % and most preferably 30 to 40 wt %. Suitable polymers include polyacrylates, alkyd polymers, cellulosic polymers, epoxy resins, polyamides, polyesters, polysulphides, polyurethanes, phenolic polymers, natural and synthetic rubbers, silicate and silicone polymers, polystyrenes, polyalkenes, for example vinyl-based polymers, and copolymers thereof.

Alternatively and/or additionally, the fire-stop product comprises a binder. Preferably a binder is present in an amount of from 1 to 90 wt %, more preferably from 5 to 70 wt %, and most preferably from 10 to 50 wt %. Suitable binders include polymers, silicone oils, mineral oils, for example polybutylene oil, water and mixtures thereof.

In some embodiments, the fire-stop product of the present invention may comprise an emulsion in which one or more polymers are dispersed in oil or water.

Fire-stop products of the present invention preferably comprise 5 to 95 wt % fillers, preferably 10 to 80 wt %, more preferably 20 to 70 wt %, preferably 30 to 60 wt %, most preferably 40 to 50 wt %. These include inert fillers and reinforcing fillers.

Suitable fillers include clays, metal oxides, silicates, barytes, carbonates, dolomites, talc, mica and silica.

Fire-stop products of the present invention preferably comprise 1 to 50 wt % fire retardant compounds, preferably 2 to 30 wt %, more preferably 5 to 20 wt % and most preferably 10 to 15 wt %.

Suitable fire-retardant compounds include aluminiumtrihydrate, carbonates, dolomites, boron compounds, antimony compounds, graphite, phosphates, halogenated compounds, melamine, magnesium hydroxide, graphite and phosphorous.

In addition to the characterising marker, the fire-stop products of the present invention may further comprise small amounts (less than 10 wt %, preferably less than 5 wt %) of the other additives and optional excipients, for example, wetting agents, dispersants, pigments, pH stabilisers and adhesion agents.

Preferably, any pigment or dye present will not be extracted by the solvent system used in the second aspect of the invention and thus the fire-stop product may be of any colour.

One useful fire-stop product according to the present invention is a fire-stop coating. Such coatings are typically applied as aqueous emulsions containing polymers, fillers, fire-retardant compounds and other additives.

Fire-stop coatings of the present invention may be produced with a range of viscosities, according to the intended method of application. Coatings may be applied, for example, by use of a trowel, by brushing or by spraying.

Fire-stop coatings of the present invention may be applied to any suitable substrate. Such coatings are often applied to mineral fibre boards used in building construction. These boards are usually formed of mineral wool, for example rock wool or glass wool and are well known to those skilled in the art.

The present invention therefore provides a mineral fibre board product coated with a fire-stop coating comprising a characterising marker as defined in accordance with the first aspect.

Fire-stop coatings of the present invention may also be applied to other substrates, for example masonry and blockwork. The use of such coatings helps prevent air movement between partitioned areas of a building. In the case of blockwork, the application of such coatings is particularly advantageous due to the porous nature of blockwork.

According to a second aspect of the present invention, there is provided a method of identifying a fire-stop product by establishing the presence of a characterising marker.

Preferably the method of the second aspect is convenient and easy to perform.

The method or the second aspect preferably takes less than 60 minutes to show the presence of the marker, preferably less than 40 minutes, more preferably less than 30, preferably less than 20, preferably less than 15, preferably less than 10, preferably less than 5 minutes, and most preferably less than 2 minutes.

In some embodiments the method may be carried out in situ, i.e. without the need for a sample of the product to be removed. The method may comprise applying heat or light, for example UV light, in order to reveal the presence of the characterising marker.

In an alternative embodiment, the presence of a characterising marker may be revealed by application of a chemical agent to the product.

Preferably in the method of the second aspect of the present invention, the presence of the characterising marker is established by extracting said. characterising marker from a sample of the fire-stop product using a solvent system, and then performing a simple diagnostic test on the extracted solution (hereinafter called “the extract”).

Suitably the sample of the fire-stop product to be identified is removed from a location to which it has been applied and the method of the second aspect is carried out in the vicinity of this location. Thus, the method of the second aspect may be carried out at the site where the product is located. This is defined in relation to the first aspect.

The characterising marker may be extracted from the fire-stop product using any suitable solvent system. A solvent system may comprise one or more solvent. Suitable solvents include water; alcohols, for example ethanol and methanol; esters, for example ethyl acetate; ketones, for example acetone; aldehydes, for example formaldehyde; amides, for example dimethylformamide; amines, for example triethylamine and pyridine; aromatic compounds, for example toluene and benzene; carboxylic acids, for example ethanoic acid; ethers, for example diethyl ether and tetrahydrofuran; sulphur-containing solvents, for example dimethylsulphoxide; and halogenated solvents, for example dichloromethane or chloroform.

Preferred solvents for use in the present invention are non-toxic solvents. Most preferably the solvent system used to extract the characterising marker of the fire-stop product of the present invention comprises water. Preferably it is water or an aqueous solution.

In some embodiments, the diagnostic test merely comprises observing the extracts taken from the fire-stop product using the solvent system which contain the characterising marker. For example it may be possible to observe a colour change or effervescence, following the dissolution of the characterising marker in the solvent system.

In an alternative embodiment, the simple diagnostic test may comprise measuring the temperature of the dissolved extract. There may, for example be an exothermic or endothermic reaction which occurs, and this could lead to a change in temperature which could be measured.

In a further alternative embodiment, the simply diagnostic test may comprise performing chromatography on a sample of the extract. It may comprise measuring the ultra violet, or infra red spectra of the extract.

In preferred embodiments, the diagnostic test comprises the addition of a diagnosis agent to the extract. The diagnosis agent may be added to the extract, i.e. to the solvent system comprising the characterising marker following extraction. Alternatively, the diagnosis agent may be added to the solvent system prior to extraction such that a mixture of the solvent system and the diagnosis agent may be used to extract the characterising marker. Optionally, where the diagnosis agent is a liquid, the solvent system may comprise or consist of the diagnosis agent.

The diagnosis agent may suitably react with the characterising marker contained in the extract to cause a physical change. Preferably the physical change is a change in colour. Most preferably the change in colour occurs due to a change in pH.

Preferably the extract (comprising the characterising marker) initially has a pH of between 5 and 9, more preferably of between 6 and 8.

The extract may be a solution of any colour. Preferably it is a colourless solution.

Preferably the diagnosis agent comprises an acid or a base. Any acid or base may be used. Preferably the diagnosis agent comprises an aqueous solution of a water soluble acid or base, although in an alternative embodiment, neat (solid or liquid) acid or base could be added to the extract. However, this is undesirable as such compounds are typically highly corrosive. Acid or base solutions suitable for use in the method of the second aspect of the present invention include aqueous solutions of hydrochloric acid, sulfuric acid, nitric acid, phosphoric acid, acetic acid, sulfamic acid, sodium carbonate, sodium bicarbonate, sodium hydroxide, lithium hydroxide, lithium carbonate, lithium hydrogen carbonate, potassium hydroxide, potassium carbonate and potassium hydrogen carbonate.

Most preferably the diagnosis agent comprises a solution of an alkali metal hydroxide, most preferably sodium hydroxide. Preferably the diagnosis agent comprises at least 0.01 wt % sodium hydroxide, more preferably at least 0.05 wt %, more preferably 0.1 wt %, more preferably 0.5 wt %, but most preferably at least 0.9 wt %.

Preferably the diagnosis agent comprises up to 50 wt % sodium hydroxide solution, preferably up to 30 wt %, preferably up to 15 wt %, preferably up to 10 wt %, preferably up to 5 wt %, preferably up to 2 wt %, preferably 1.5 wt %, and most preferably up to 1.1 wt %.

In the method of the second aspect of the present invention, extraction of the characterising marker from the fire-stop product may be achieved by any suitable means.

Preferably, a sample of the fire-stop product is simply added to the solvent system and the characterising marker is able passively diffuse throughout the solvent.

Preferably, only the characterising marker dissolves and the sample of fire-stop product remains otherwise unaffected.

In as especially preferred embodiment, the method of the second aspect of the present invention comprises the steps of:

(a) selecting a sample of fire-stop product;

(b) adding the sample of fire-stop product to a solvent system;

(c) adding a diagnosis agent to the solvent system; and

(d) observing a colour change.

In the preferred method, steps (b) and (c) may be carried out in any order and the solvent system may comprise or consist of the diagnosis agent.

According to a third aspect of the present invention, there is provided apparatus for performing a simple diagnostic test to establish the presence of a characterising marker contained in a fire-stop product in order to identify said fire-stop product, the apparatus comprising a solvent system for extracting the characterising marker, and a diagnosis agent.

The solvent system and diagnosis agent are preferably as defined in accordance with the second aspect and the solvent system may comprise or consist of diagnosis agent.

Suitably, the apparatus further comprises a container in which the simple diagnostic test may be carried out. Preferably the container is clear such that light may pass through and allow a tester to observe the contents through the side of the container. The size of the container will depend on the size of the sample of fire-stop product taken. Typically this will be a portion of product having a mass of between 0.1 g and 5 g, and a surface area of between 0.5 cm² and 100 cm². The skilled person would readily understand the size of container necessary to carry out the diagnostic method. It is also within the capabilities of the skilled person to estimate the appropriate quantities of solvent system and diagnosis agent to use, although in preferred embodiments instructions would be provided.

Preferably the container of the apparatus of the third aspect comprises a glass or polycarbonate jar. Optionally, a second glass or polycarbonate jar may be provided.

This would allow a comparative test to be carried out. A first sample of fire-stop product could be added to a first jar comprising only solvent system. No colour change would be observed. A second sample of fire-stop product could be added to a second jar comprising the solvent system and diagnosis agent. A colour change would then be observed. The ability to carry out a control test may provide enhanced consumer satisfaction.

According to a fourth aspect of the present invention, there is provided a kit for installation and identification of a fire-stop product, the kit comprising a fire-stop product comprising a characterising marker, and apparatus for identification of said characterising marker.

The fire-stop product preferably is as defined in accordance with the first aspect of the present invention and may include any of the features thereof.

The apparatus for identification of the characterising marker may comprise any suitable means.

suitably it comprises a solvent system for extracting said characterising market and equipment for carrying out a simple diagnostic test on the extract.

The equipment for carrying out the simple diagnostic test may comprise any suitable means.

It may comprise, for example, a thermometer or thermocouple for measuring a change in temperature.

It may comprise a colorimeter or spectrometer for measuring a colour change, or a spectroscopic data of the characterising marker.

Suitably the apparatus is portable and may be taken easily to the site where the fire-stop product is located. Preferably the apparatus is as defined in accordance with the third aspect of the invention and may include any of the features thereof.

According to a fifth aspect of the. invention, there is provided the use of a characterising marker to identify a fire-stop product.

The invention will now be further described by way of the following non-limiting examples:

### EXAMPLE 1

A fire-stop sealant product was prepared having the following formula:

Acrylic copolymer in aqueous emulsion—36 wt %

Fillers—47 wt %

Aluminium trihydrate—12 wt %

Additives—4.9 wt % (including wetting agents, dispersants, pigments and stabilisers)

Phenolphthalein—0.1 wt %.

This sealant was applied in the usual manner to fixtures within a building. After 6 months, a sample of the sealant was tested on site.

Two small samples of sealant (approx. 1×0.5×0.2 cm) was taken. A first sample was added to a glass jar comprising 15 cm³ distilled water. No colour change was observed—a colourless solution remained. The second sample was added to a glass jar comprising 15 cm³ of a 1 wt % aqueous solution of sodium hydroxide. After 1 minute, it was observed that the initially colourless solution turned pink. This indicated that the characterising marker, phenolphthalein was still present in the fire-stop sealant.

### EXAMPLE 2

A fire-stop coating product was prepared having the following formula:

VA Veova in aqueous emulsion—30 wt % (vinyl acetate vinyl versatate ester copolymer)

Fillers—30 wt %

Aluminium trihydrate—7 wt %

Water—25 wt %

Pigment—4.3 wt %

Additives—3.6 wt %

Phenolphthalein—0.1 wt %.

The coating is suitable for application to mineral fibre boards, for example by spray, brush or trowel application. The coating can also be used on site to seal the surface of masonry, blockwork or other construction materials. The coating helps to prevent air movement between partitioned areas of a building.

1. A fire-stop product comprising a characterising marker, wherein the presence of said characterising marker can be detected by a diagnostic method at the site where the product is located.

2. A fire-stop product according to claim 1 wherein the characterising marker is a stable chemical component which can be detected in the fire-stop product after a period of at least a year.

3. A fire-stop product according to claim 1 wherein the characterising marker is present in the fire-stop product in an amount of from 0.001 to 1 wt %.

4. A fire-stop product according to claim 1 wherein the characterising marker comprises a chemical component which may be selectively extracted using a solvent system.

5. A fire-stop product according to claim 1 wherein characterising marker is initially invisible and is detected because in the diagnostic method used to detect the marker, a colour change occurs.

6. A fire-stop product according to claim 1 wherein the characterising marker comprises a pH indicator.

7. A fire-stop product according to claim 1 wherein the characterising marker comprises phenolphthalein.

8. A fire-stop product according to claim 1 wherein the fire-stop product is selected from a fire-stop sealant, a fire-stop coating, a fire-stop adhesive and a fire-stop putty.

9. A mineral fibre board product coated with a fire-stop coating comprising a characterising marker as defined in claim 1.

10. A method of identifying a fire-stop product by establishing the presence of a characterising marker.

11. A method according to claim 10 wherein the presence of the marker is established in less than 5 minutes.

12. A method according to claim 10 wherein the presence of the characterising marker is established by extracting said characterising marker from a sample of the fire-stop product using a solvent system, and then performing a simple diagnostic test on the extracted solution.

13. A method according to claim 12 wherein the diagnostic test comprises the addition of a diagnosis agent to the extracted solution.

14. A method according to claim 13 wherein the diagnosis agent comprises an acid or a base.

15. A method according to claim 10 comprising the steps of:
(a) selecting a sample of fire-stop product;
(b) adding the sample of fire-stop product to a solvent system;
(c) adding a diagnosis agent to the solvent system; and
(d) observing a colour change.

16. A kit for installation and identification of a fire-stop product, the kit comprising a fire-stop product comprising a characterising marker, and apparatus for identification of said characterising marker.

17. A kit according to claim 16 wherein the apparatus comprises a solvent system for extracting the characterising marker, and a diagnosis agent.

18. The use of a characterising marker to identify a fire-stop product.
